(19) United States
(12) Patent Application Publication
(10) Pub. No.: US 2015/0273478 A1
(43) Pub. Date: Oct. 1, 2015

(54) HIGH-SPEED MILL

(71) Applicant: UNIVERSIDAD DE SANTIAGO DE CHILE, Santiago (CL)

(72) Inventors: Alejandro Gutierrez Silva, Santiago (CL); Jules Guichou Leighton, Santiago (CL)

(73) Assignee: UNIVERSIDAD DE SANTIAGO DE CHILE, Santiago (CL)

(21) Appl. No.: 14/431,121

(22) PCT Filed: Sep. 25, 2013
(86) PCT No.: PCT/IB2013/058862

§ 371 Date: Mar. 25, 2015

(30) Foreign Application Priority Data
Sep. 26, 2012 (CL) 2668-2012

(51) Int. Cl. B02C 19/00; B02C 23/16; B02C 7/06

(52) U.S. Cl. CPC B02C 19/0012; B02C 7/06; B02C 23/16; B02C 2023/165

(57) ABSTRACT

A grinding mill for ore or granular material capable of reducing ore or granular material of large size to a smaller size in only one device comprised by a chamber or compartment of fixed cylindrical shape, provided with at least a window for feeding the material in a radial position preferably vertical and at least one window for radially releasing said material antagonistic to the feeding window, the device being provided with a mechanism which provides the material with movement inside the chamber wherein the device which provides the material with movement is a rotatory plate which generates a cavity inside the fixed chamber wherein the material is housed, the rotatory plate having preferably flats non-parallel faces, a face perpendicular to the axial axis and the other face being inclined, on the face perpendicular to the axial axis is supportively positioned the driving axis which provides the rotational movement, the plate has the rotation axial axis preferably in a horizontal way, the inclined face being in contact with the material to be ground and is provided with lifting elements which pull the material by inducing in it a rotational and translational movement in the axial direction, this axial movement makes the material to compress against a fixed or movable wall (translation and/or rotation) positioned in an antagonistic way to the inclined face, thus generating the friction, compression, impact and attrition mechanisms of the material, considerably fracturing the structure thereof and achieving its size reduction.

### TECHNICAL FIELD OF THE INVENTION

The present invention relates to an ore grinding mill which is constituted by a chamber or static container of a preferably cylindrical shape of axial axis, horizontally positioned and in the interior of which is found the material to be ground and grinding means, the grinding is produced due to the movement of the bodies interacting between each other, movement which is produced by means of a preferably flat and rotatory surface which is inclined with respect to the transverse plane, and provided with metal indentations for the wear, delimited by the cylinder. This surface when being rotated and inclined, produces for the ore and grinding means a translation and rotation movement inside the cylindrical cavity, increasing the relative movement among them, thus generating a great number of impacts and, on the other hand, the bodies remaining inside the bed are subject to great compressions, thus producing the fracture of materials and therefore its size reduction; simultaneously the material which does not reach a sufficient energy level in order for this to impact other materials and grinding means, slide through the surface with great relative movement, causing a wear which also has as an objective the size reduction of the material.

Therefore, in this new device are identified abrasion, impact and compression mechanisms also existing in other grinding devices, however here they show a greater intensity when operating, thus taking advantage in the best possible way of the supplied energy and thereby achieving a great energy saving.

It should be highlighted the fact that when rotating the inclined surface with respect to the horizontal axis, the grinding chamber changes its shape from a close configuration on the upper part and open configuration on the lower part, in an exactly opposite configuration at 180° from it, thus allowing a material flow from the loading to the unloading stage in a fast way, thereby increasing its processing capacity.

### APPLICATION FIELD OF THE INVENTION

Particularly, the present invention relates to a device which allows grinding material with applications in the mining industry of metallic, non-metallic and arid materials. More particularly, this invention relates to a device constituted by a receptacle which interior contains the material to be ground and grinding means, the geometry of the receptacle being such that it allows generating movement of the material as well as of grinding means in such a way it is generated a geometry of movement, similar to the one nowadays is produced in the conventional mills and crushers. In this invention said movement is performed when having a inclined surface which rotates on a horizontal axis, causing a distancing and approaching movement from the material with respect to the opposite static wall such as the one produced in a crusher, and on the other hand, due to the rotating movement the bodies are pulled in a rotational way, thus generating a waterfall and cascade movement similar to the one produced in a conventional mill. Great advantages are obtained with regard to current procedures commonly used in the industry, the most important are: there is only one element with relative movement, that is, the big rest systems are minimized and thereby the lubrication is minimized in this new type of mill, the rotating element is subject to its own weight and an axial load and not to the load to be ground, therefore, the radial reactions on the supports are of lesser magnitude with respect to the existing conventional mills; another advantage is that it is not necessary to incorporate linings on the upper zones, because it will be very difficult for the material to be ground to reach said zone. The major advantage results in a considerable reduction of the energy consumption, due to the fact that are preferably moved the elements which will be subject to reductions of size and grinding means. With regard to the power system, the driving system is based on electrical and/or hydraulic engines, which is a very developed and reliable technology. Finally as an additional advantage it should be indicated that the new mill has the classification system incorporated inside the equipment, thus saving space in the plant, etc.

In summary, it can be mentioned that the present invention is an integration of three processes in one equipment, such as crushing, grinding and classification.

### COMMENTS ON THE PREVIOUS ART

The traditional comminution system since around hundreds of years has been approximately the same all around the world. It starts with the blasted mineral coming from the strip mine with a maximum size of 1.5 m, with which is fed to the primary crusher that reduces it to a size of 0.10 m, subsequently, this material passes to a secondary crusher which reduces it to a size of 0.07 m, afterwards, this material passes to a third crusher, reducing the mineral to a size of approximately 0.005 m in order to finally feed this material to a ball mill and thereby reducing it to a 200 μm (65 mesh).

The aforementioned traditional process has experimented some modifications which results in the incorporation of a new type of semi-autogenous grinding (SAG) and this is how the process flow is modified, starting with a primary crushing which reduces the mineral to a size of 0.2 m, then it passes to the semi-autogenous mill SAG, and afterwards to 2 or 3 ball mills which allow reducing the material to a size of 200 μm (65 mesh).

The currently valid comminution principle is based on the fracture of the mineral by impact among the steel balls and the mineral, as well as the impact among the mineral parts. The fracture process is produced when continuously rotating around its axial axis a cylinder of great weight, the diameter of which varies according to the mill, however it can be preferably of 1.5 and 13.5 meters which contains grinding means (generally steel balls) and mineral which jointly are referred to as load.

In order to move this huge weight as is the case of SAG mills which can reach in total more than 1500 tons, a great quantity of energy is required. More than 90% of this energy is used for moving the total load and the difference is used in the comminution process itself.

The current process based on mills consists of introducing into a cylindrical receptacle which is provided with conic covers and having openings that allow on one side to introduce the material and on the other end they allow to release the same, however with other size (grain size), this size reduction is achieved by using three mechanisms which result from the movement of the introduced load and grinding means, said mechanisms are impact, friction and compression.

The cylindrical recipient containing material and grinding means (balls) is provided with recesses which allow the turning on the axial axis of the cylinder, when rotating this component, it is produced a dragging of the material which tries to get attached to the walls of the cylindrical mantle, this attachment is broken when the gravitational forces prevail and control the friction forces which has as an effect that the material and the grinding means fall down and impact other elements thus producing the rupture of the material, this zone is referred to as cataract.

Simultaneously, a relative movement zone is originated which produces a great wear as a result of the friction between each other, this zone is referred to as cascade, finally, in the inner zone, the particles of the material are subject to a great level of pressures, thus causing a weakening (micro-fractures) of the material.

If we analyze a cross cutting of the chamber it is possible to observe that the movement being acquired by the load, the particles and grinding means are positioned on the side of the vertical axis of the section and depends on the direction of the rotation of the mill. For example, if the direction of the rotation of the mill is counter-clockwise, the material is positioned on the right side of the vertical axis passing through the center of the mill. This causes an eccentricity of the load, therefore, it should be added a force such that or a torque which balances this eccentricity and thus causing a rotation movement at a constant speed. As the eccentricity as well as the load are big, a big torque has to be applied which together with the speed that the system must have in order to produce effects such as cataract, cascade and pressure, it is necessary to apply a big power. As it will be observed, the consumed power is not applied to the specific process of the material reduction, but to the moving of the load and causing that a reduced number of particles are found in the air and due to a gravitational effect they impact the others thereby producing its rupture.

The comminution process currently also incorporates a stage for crushing material, operation which is carried out in a device containing at least two rigid surfaces having a movement relative to each other, of approaching and distancing between them in this way when introducing the material inside, the surfaces comprise the material, causing the fracture thereof. There are two preferred embodiments in this crushing device, the first consists of two flat surfaces positioned with an initial opening angle which varies to one of little magnitude in a cyclic way, on the other hand this approach between the surfaces is performed by two cones of vertical axial axis having different taper and of axes cutting each other, that is, wherein one of them is inclined with respect to the other, when printing a rotational movement to the cone of little magnitude, remaining fixed the one of greater magnitude and it is produced the approach between the surfaces, pressing the bodies and producing the fracture thereof.

The present invention keeps the best of both mill and crusher equipment, since it replaces from the traditional system the rotatory compartment of the cylindrical mantle of the mill by a static compartment having a geometry which makes easier the creation of the cataract, cascade and pressure effects.

The energy is only used to move the inclined plate on the axial axis of the cylinder which is provided with indentations causing a rotational movement of the material and grinding means, as well as a translational movement in the axial direction due to the inclination of the plate, in this way it is produced an integration of two pieces of equipment such as the crusher and the mil, thus achieving substantial advantages with regard to the operation time, since both the crushing process and the grinding are performed in a same device, this condition has an effect on the energy saving, since there is no need to transport material and improves the interference process of the bodies in movement.

U.S. Pat. No. 4,222,528 presents a mill which relates to the present invention when maintaining fixed the outer surface of the container and the horizontal axis, on its central part are positioned elements which rotate about its axis and the material is pulled by a fluid which leads it towards the rotatory element which is provided with indentations that are the ones producing the fracture of the material.

U.S. Pat. No. 6,789,756 relates partially with the present invention, since it maintains stationary the casing, however in this patent the comminution is achieved when injecting the fluid at high speed tangentially and about a vertical axis, providing the fluid with a movement which floods all the compartment or recipient and that when incorporating perturbations to the fluid jet it makes that the particles inside of it are in disorder and collide, in this way the material reduction is produced. Inside this mill great speeds are generated and at all times the fluid wrap the particles, thereby causing an absorption on the collisions. With regard to the present invention, it is only taken the concept of the fixed casing, since high pressure fluid is not used to move the material.

U.S. Pat. No. 4,886,216 describes a system provided with a fixed outer casing preferably in a cylindrical shape with a vertical axial axis in which interior is found a concentric axis with respect to the casing having rigidly attached a great quantity of plates which have wear elements radially positioned, each plate defining a grinding chamber and the material reduces its size as it displaces towards the unloading stage which is produced by the action of gravity.

U.S. Pat. No. 5,950,939 presents a typical configuration of cone crusher that is provided with a vertical axis having a fixed cone with an upper diameter greater than the lower one in the shape of a cavity. Another cone of little diameter is inverted which is introduced inside the fixed cone, leaving enough space so as the material can drain, which passes by gravity effect and gets out by means of the lower part. The walls of the cones get closer and get distanced due to the inclination of the axis of the upper cone which is rotating and articulated on its upper part.

The patents of the previous art have the distinctive feature of using one or several chambers which are with or without fluid and which contain particles which when acquiring speed due to the pulling effect of walls or fluid and given the nature of the fluid (it varies according to the time) it makes the particles to collide among each other and on the fixed and/or movable surfaces, thereby causing the rupture of the material.

### DESCRIPTION OF THE FIGURES

FIG. 1 shows an example which allows visualizing in a generic way the present invention.

FIG. 2 shows a whole cross-section of the assembly, indicating the zones and different components.

FIG. 3 shows a description of the main components in sectional view, allowing to observe the inner zones in more detail as well as the feeding and unloading stages.

FIG. 4 shows a detail of the flow inside the device in its maximum feeding aperture condition.

FIG. 5 shows a detail of the flow inside the device in its maximum unloading condition.

### DETAILED DESCRIPTION OF THE INVENTION

The present invention captures the idea of having a static chamber having in its interior a rotatory inclined plate which provides the material with movement and in order to improve the comminution grinding means are added, which results in a combination between a crusher and a mill.

The more important technological impacts of this mill at a high speed is that its casing does not rotate, the rotation and translation movements of the material are coupled, thus simultaneously producing abrasive wear and fracture by compression. In the case that grinding means are introduced for example, balls, the movement thereof will be similar to the one happening in a conventional mill adding the impact mechanism to the process.

In order to make the device more functional, this has been provided with a series of accessories which considerably improve its functioning.
Due to the container is fixed, the feeding of the loading is performed by means of a feeding compartment positioned in the upper part which uses gravity as a transportation source which is directly coupled to the container, thus avoiding material leaks, since there is no relative movement between them as often currently occurs.
The unloading of the material is performed on the upper part, by adding grids with sizes such that they allow the adequate classification and release the low size material in a fast way, due to this material is pulled by the fluid existing in the interior. The injected fluid makes the release of materials having passed through the classification stage easier.
In the interior part are incorporated protection elements of the casing of the compartment, however they are preferably positioned on the lower part due to the fact that on the upper part there is no contact of material and grinding means with the walls of the container. In this way, it is minimized the replacement time of linings with the subsequent increases with regard to the equipment availability. Both the rotatory inclined plate and the fixed opposite plate are provided with wear elements.
The container when being static, allows decreasing the size of the safety zone of the system since there is no surfaces in movement which can interact with the operation or maintenance personnel.
The system has the same protection devices existing for crushers and mills.
The non-rotatory plate is provided with an unlocking system which is automatically unblocked in an elastic way, when a high loading occurs in the axial direction, in such a way that it can immediately return to its initial position.

### SUMMARY OF THE INVENTION

The invention object of the present patent application refers to a new ore grinding system supported by a static chamber or compartment of a preferably cylindrical geometry with a horizontal axial axis which does not rotate about its axis. In its interior in its preferred configuration is found the material and grinding means which will be referred to as loading and the movement of which inside the container is performed by the action of a rotatory inclined plate in a horizontal axis concentric to the one of the chamber which pulls the material in a circular way and also provides it with an axial movement. Therefore, the movement provoked to the material and grinding means is similar to the movement produced in a conventional mill, identifying the mechanisms and grinding classical zones such as the cataract effect, the cascade effect and the pressure. The compressive effect is not limited to the gravitational type of loading which exerts the material on itself, since in this case due to the approach of the rotatory surface in a cyclic way, makes the bodies to compress against the antagonistic fixed surface, thus considerably increasing the compression effects and therefore producing a major fracture of the material. The mill is provided with a protection system composed by elastomer elements and/or compressible elements which allow the inclined plate to displace in the axial direction when the loadings over the plates are high.

### PREFERRED EMBODIMENT OF THE INVENTION

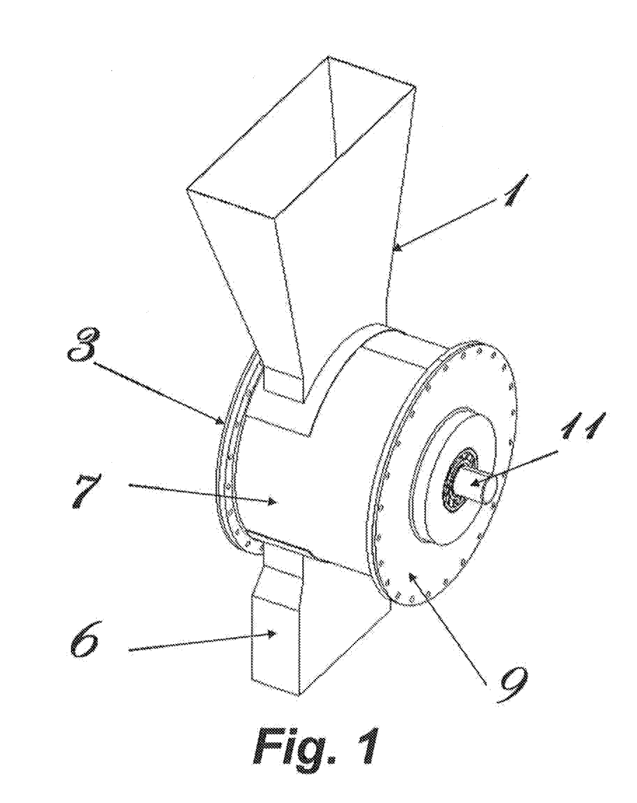

FIG. 1 shows an example which allows visualizing in a generic way the present invention.

It is observed a feeding compartment (1) composed by smooth surfaces with an inclination which canalize the material to be subject to the grinding, the grinding chamber is limited by the surfaces (3) and (9) which correspond to fixed covers and a cylindrical mantle (7). On the lower part is positioned an unloading compartment (6) formed by smooth surfaces which makes easier the unloading stage. Finally, this figure shows the rotatory axis (11) which in its inner part has fixedly attached an inclined plate.

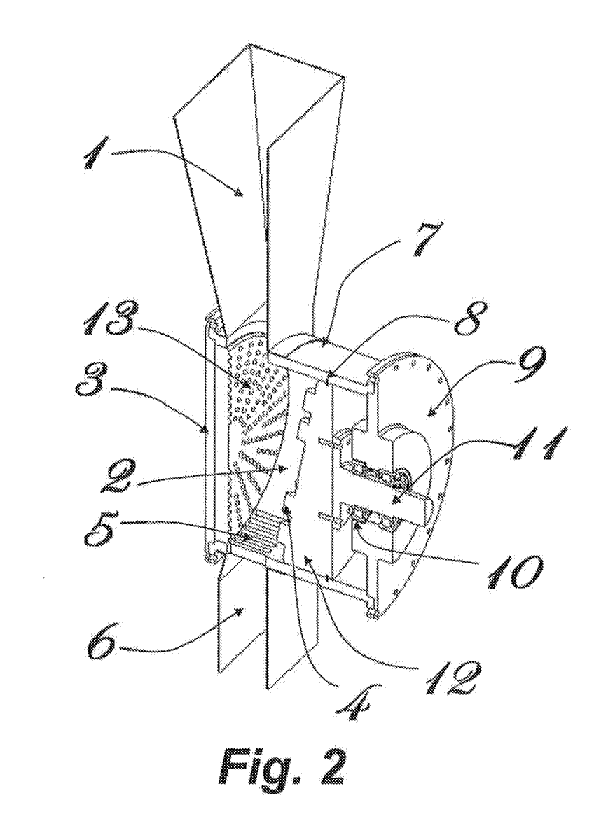

FIG. 2 shows a whole transversal cut of the assembly, indicating the zones and different components. The zone (1) corresponds to the cutting of the feeding recipient which receives the material and falls inside the chamber (2) which changes the shape when rotating the plate (12), the spot (10) corresponds to the bearing system which is coupled to the cover (9) and connects the axis (11) which is rigidly attached to the plate (12), this plate has a flat face on the side that is attached to the axis (11) and on its other end the plate is inclined with an angle α preferably comprised between 2° and 45°, this plate (12) being provided with indentations of different geometry (4) of high resistance material which are aimed to move the material inside the chamber while also being wear elements.

The cover (3) is comprised by two elements, the cover itself and an inner surface (13) provided with wear-resistant indentations which allow an axial displacement which is activated when the pressure is increased as a result of the compression of the materials and grinding means.

The inner surface (13) can contain elastomers or actuators of the hydraulic and/or pneumatic type in order to allow the axial movement by releasing the rotatory plate when in presence of an axial overload.

On the lower part of the chamber (2) an unloading grid (5) is positioned which regulates the size of the release material and which unloads in the compartment (6) canalizing the ground material to another device. The inclined rotatory face has a rotational speed which is in the range of 20% to 10000% of the critical speed of a conventional mill of similar diameter. The surface antagonistic to the rotatory inclined face has a system based on elastomers which allows decreasing the great axial forces that are produced when the system tends to get blocked. In addition, the inclined surface antagonistic to the rotatory face is in rotational movement synchronized with a time difference.

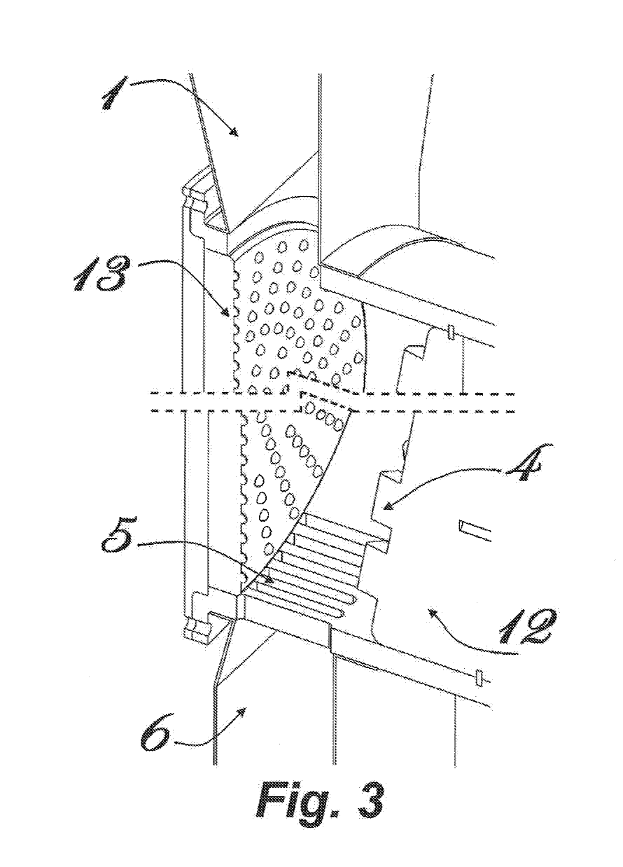

FIG. 3 shows a description of the main components in cutting view, allowing to observe the inner zones in more detail. In this figure is possible to observe that the fixed plate (13) has incorporated wear elements similar to the existing drilling tools.

In this same FIG. 3 is shown a detail of the feeding and unloading zone wherein it is shown a surface (13) which has an elastomer system which allows unblocking the system, a feeding recipient (1), an unloading grid (5) and indentations (4) supportive with respect the movable inclined plate (12) and also having an unloading recipient (6).

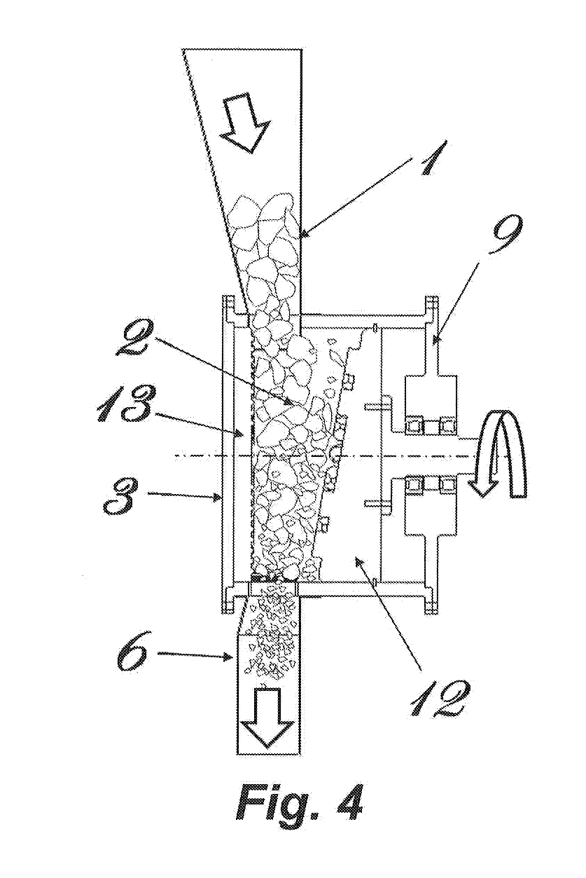

FIG. 4 shows a detail of the flow inside the device in its maximum feeding aperture condition since the rotation axis is horizontal and this has rigidly attached a plate to it that is inclined in this position, it reflects the greater aperture on the upper part, thus allowing the entrance of the material to be ground. In said instance, on the lower part, the plate is closer to the surface (13), producing a high compression of the material positioned on the lower part of the chamber, thereby reducing its size.

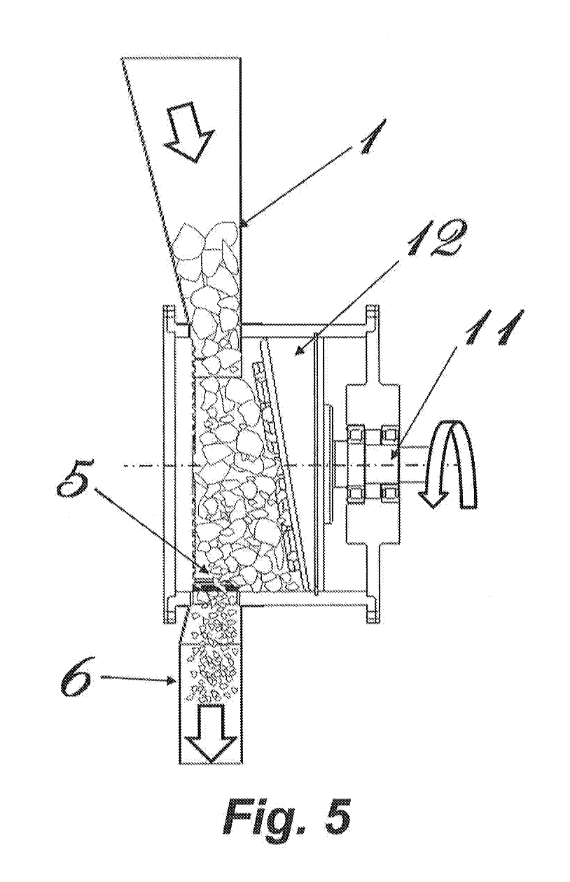

FIG. 5 shows a detail of the flow inside the device in its maximum unloading condition. This position is antagonistic to the one described in FIG. 4, since now the plate is in the maximum unloading zone, identifying a zone which allows releasing the material of smaller size, passing through the grid (5) and being unloaded to the unloading recipient.

1. An ore or granular material grinding mill capable of reducing ore or granular material of large size to a smaller size in only one device comprised by a chamber or compartment of fixed cylindrical shape, provided with at least a window for feeding the material in a radial position preferably vertical and at least one window for radially releasing said material antagonistic to the feeding window, the device being provided with a mechanism which provides the material with movement inside the chamber characterized in that the device which provides the material with movement is a
rotatory plate which generates a cavity inside the fixed chamber wherein the material is housed, the rotatory plate having preferably flat non-parallel faces, a face perpendicular to the axial face and the other is an inclined face, on the face perpendicular to the axial axis is supportively positioned the driving axis which provides the rotational movement, the plate has the rotational axial axis preferably in a horizontal way, the inclined face is in contact with the material to be ground and is provided with lifting elements which pull the material, providing for it a rotational and translational movement in the axial direction, this axial movement makes the material to compress against a fixed or movable wall (translation and/or rotation) positioned in an antagonistic way to the inclined face, thus generating the friction, compression, impact and attrition mechanisms of the material, considerably fracturing its structure and achieving its size reduction.

2. The ore or granular material grinding mill according to the claim 1 characterized in that said inclined rotatory face has an inclination angle α of the inclined surface of the plate comprised between 2° and 45°.

3. The ore or granular material grinding mill according to the claim 1 characterized in that said inclined rotatory face has a rotational speed which is comprised between 20% to 10000% of the critical speed of a conventional mill of similar diameter.

4. The ore or granular material grinding mill according to the claim 1 characterized in that the surface antagonistic to the rotatory inclined face has a system based on elastomers which allows decreasing the great axial forces that are produced when the system tends to get blocked.

5. The ore or granular material grinding mill according to claim 1, characterized in that the inclined surface antagonistic to the rotatory face has a rotational movement synchronized with a phase difference.

6. The ore or granular material grinding mill according to the claim 1 characterized in that the surface antagonistic to the rotatory surface has a system based on hydraulic and/or pneumatic actuators which allow decreasing the great axial forces that are produced when the system tends to get blocked.

7. The ore or granular material grinding mill according to the claim characterized in that the antagonistic surface and the inclined rotatory surface are provided with high resistance indentations which increase the working life thereof.

8. The ore or granular material grinding mill according to the claim 1 characterized in that it has a chamber that when rotating the inclined face a movement is produced for the material which considerably improves the flow and accelerates the residence time in its interior.

9. The ore or granular material grinding mill according to the claim 1 characterized in that the chamber is shaped for lifting the material and grinding means which when falling down, impact and produce the fracture of the material and therefore a size reduction thereof.

10. The ore or granular material grinding mill according to claim 1 characterized in that the chamber is provided with wear elements which increase the working life thereof.

11. The ore or granular material grinding mill according to claim 1 characterized in that the chamber has on its lower part a classifying device which regulates the minimum size of the material and grinding means which must circulate until the material can pass through it.

12. The grinding mill of ore or granular material according to claim 1 characterized in that the chamber is injected with a fluid which makes easier the release of the materials that have already passed through the classification.

13. The grinding mill of ore or granular material according to claim 1 characterized in that grinding means (balls) which help to the comminution are added inside the chamber.
